(19) United States
(12) Patent Application Publication
(10) Pub. No.: US 2018/0052754 A1
(43) Pub. Date: Feb. 22, 2018

(54) PERFORMANCE METRIC CONTEXTUALIZATION IN A DISTRIBUTED COMPUTING ENVIRONMENT

(71) Applicant: CA, Inc., New York, NY (US)

(72) Inventors: Erhan Giral, Saratoga, CA (US); Martin Tali, Foster City, CA (US); Ramesh Mani, Fremont, CA (US); Anand Krishnamurthy, Fremont, CA (US)

(21) Appl. No.: 15/396,095

(22) Filed: Dec. 30, 2016

Related U.S. Application Data
(63) Continuation of application No. 15/242,270, filed on Aug. 19, 2016.

(51) Int. Cl. G06F 11/34; G06F 11/30

(52) U.S. Cl. CPC G06F 11/3409; H04L 69/329; G06F 11/302; G06F 11/3006

(57) ABSTRACT

Embodiments provide contextualization for collecting performance metrics of various application components based on values of attributes of an incoming request (a calling context). This contextualization is not limited to the highest level of the application stack. Rather, this contextualization based on attributes' values of an incoming request can be carried down through the application stack and to hardware performing operations for processes in the application stack. In other words, performance metrics can be separated based on the calling context at different levels of the application stack. Accordingly, the calling context includes a value of at least one attribute of the incoming request and a path from a top of the application stack to a location of the application component being executed.

### CLAIM FOR PRIORITY

The present application is a continuation of U.S. application Ser. No. 15/242,270, filed Aug. 19, 2016, which is hereby incorporated herein by reference in its entirety.

### BACKGROUND

The disclosure generally relates to the field of data processing, and more particularly to performance metric contextualization in distributed computing environments.

The growing presence of the Internet as well as other computer networks, such as intranets and extranets, has brought many new applications in e-commerce, education and other areas. Organizations increasingly rely on such applications to carry out their business or other objectives. Such organizations also typically devote considerable resources to ensuring that the applications perform as expected. To this end, various application monitoring techniques have been developed.

One approach involves monitoring the infrastructure of the application by collecting application runtime data regarding the individual components that are invoked in the application. This approach can use agents that essentially live in the system being monitored. For example, using instrumentation of the software, a thread or process can be traced to identify each application component that is invoked, as well as to obtain runtime data, such as the execution time of each application component. Tracing refers to obtaining a detailed record, or “trace,” of the operations a computer program executes. Traces can be used as an aid in debugging or production performance monitoring.

However, as application complexity increases, diagnosis of problems continues to be difficult and time-consuming (especially when problems span multiple processes and runtimes). When a distributed transaction or application is failing or regressing, what is going wrong, why the failure is occurring, etc., needs to be determined as quickly as possible to minimize business impact.

### BRIEF DESCRIPTION OF THE DRAWINGS

Embodiments of the disclosure may be better understood by referencing the accompanying drawings.

FIG. 1 depicts a system architecture at runtime for performance metric contextualization, according to some embodiments.

FIGS. 2-4 depict example processing of a request to determine a performance metric based on a calling context, according to some embodiments.

FIG. 5 depicts two examples of the number of accumulators created based on the number possible values of the selected attributes (and number of host devices), according to some embodiments.

FIGS. 6-7 depict flowcharts that includes performance metric contextualization based on a calling context, according to some embodiments.

FIG. 8 depicts an example computer device, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to monitoring application(s) for different business transactions. But aspects of this disclosure can be applied to many other types of applications. In other instances, well-known instruction instances, protocols, structures and techniques have not been shown in detail in order not to obfuscate the description.

Overview

Embodiments relate to collecting performance metrics of different services, operations, etc. performed by application components and invoked as part of transactions (e.g., business transaction) in a distributed computing environment. Examples of performance metrics include execution time, error rates, etc. In some embodiments, in response to a request to perform a transaction, multiple application components are executed to perform different application services, operations, etc. For example, an application stack having multiple application components can process a transaction. For instance, an application stack can include a first application component, a second application component, a third application component, etc. In this instance, a first application component can invoke execution of a second application component, which invokes, a third application component, etc. In some embodiments, the different application components can run on different host devices and/or in different runtime environments.

An application component can be any type of logical grouping of functionality, storage used, databases being accessed, etc. For instance, an application component can be utilized for operations to provide for a user login and authentication into a website. Or, an application component can be a queue or a database that is accessed during execution of the application(s). Also, the application components can be in a same or different host devices. For example, the application components can execute in different host devices in a distributed computing environment

Some embodiments provide contextualization for collecting performance metrics of various application components based on values of attributes of an incoming request (a calling context). This contextualization is not limited to the highest level of the application stack. Rather, this contextualization based on attributes' values of an incoming request can be carried down through the application stack. In other words, performance metrics can be separated based on the calling context at different levels of the application stack. Accordingly, the calling context includes a value of at least one attribute of the incoming request and a path from a top of the application stack to a location of the application component being executed.

An example attribute of a request includes a type of transaction (e.g., checkout). Another example attribute is a geographic origin of the request. For instance, if the transaction originates from a user whose device is located in Europe, the geographic origin is Europe. The geographic origin can be based on continent, country, state, city, etc. Accordingly, a performance metric such as error rate can be specific to a value of one or more attributes of the request. For instance, a first average error rate can be determined for a first request that is a checkout of item X from North America, and a second average error rate can be determined for a second request that is a checkout of item Y from Asia. Additionally, separation of performance metrics is not limited to values of attributes of the request being received at the top of the application stack. In some embodiments, performance metrics can also be separated based on identification (ID) of host device in which the application component is executing.

Terminology

This description uses the term “application component” to refer to any logical partition of functionality, hardware used to execute portions of the application (e.g., processor), data storage used during execution of the application (e.g., queues, databases, etc.), or any other components usable within the application. For instance, an application component can be operations (e.g., a servlet) to provide for a user login and authentication into a website. In another instance, an application component can be operations to allow a user to access their account balance from an account balance database. An application component can also be a database from which data is accessed during execution of the application. Additionally, an application component can be some type of queues or other data structures used during execution of the application.

This description uses the term “application stack” to refer to an ordered collection or set of application components that are executed to complete a particular task, service, etc. In some embodiments, the application components are in a distributed computing environment, such that at least some of the application components are executing in different host devices (and possibly running different types of runtimes and operating systems). The application components in an application stack can be ordered from top to bottom. For example, assume the application component includes application component A, application component B, application component C, etc. Also, assume that application component A is at the top of the application stack, application component B is below application component A, application component C is below application component B, etc. In this example, some type of request, instruction, call, etc. can be received by application component A. For example, application component A can receive a request from a user to purchase an item from an online website. During its execution, application component A calls application component B to perform a service, determine a result, provide data, etc. In turn, during its execution, application component B calls application component C to perform a service, determine a result, provide data, etc. This traversal through the application stack can continue until the application component at the bottom of the application stack is executed. After the application component at the bottom of the application stack has been executed, the thread of execution can move back up the application stack. For example, after application component C has completed execution, application component B can complete execution. In turn, application component C can then complete execution.

Example System Architecture

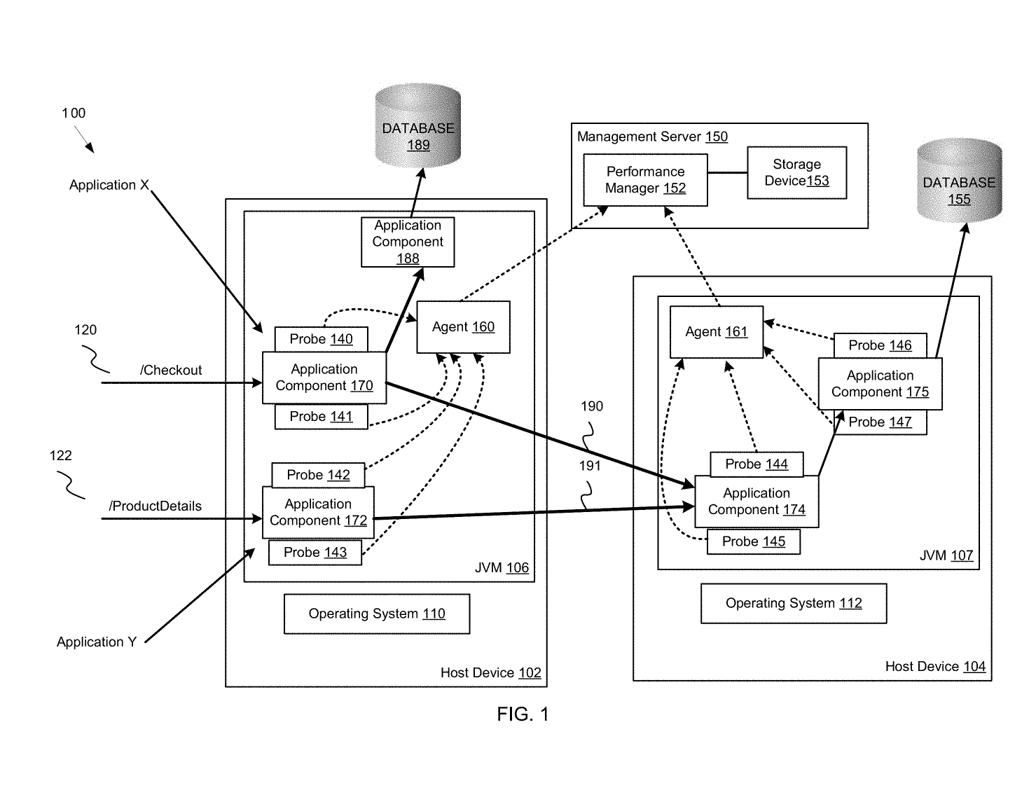

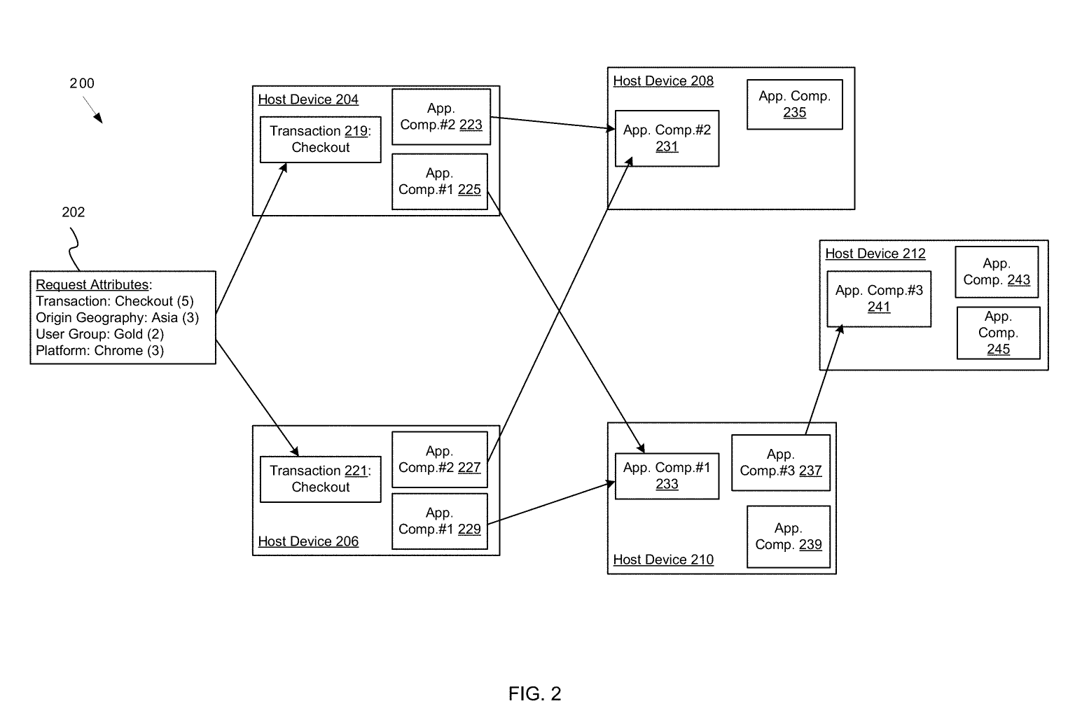

FIG. 1 depicts a system architecture at runtime for performance metric contextualization, according to some embodiments. FIG. 1 depicts a system 100 that include host devices 102-104 communicatively coupled to a management server 150. In this example, the system 100 includes two host devices. However, the system 100 can include one or more host devices. An example of a system having five host devices is depicted in FIGS. 2-4, which are described in more detail below. Examples of the host devices 102-104 may include application servers or any other type of computing device having a processor for executing code to achieve a desired functionality. The host devices 102-104 can be located remotely from one another or co-located. The management server 150 includes a performance manager 152 and a storage device 153. The performance manager 152 can be hardware, software, firmware, or a combination thereof. The performance manager 152 can access the storage device 153 to store data received from the host devices 102-104 and to provide to the host devices 102-104.

The host device 102 includes an instance of a Java Virtual Machine (JVM) 106 running on an operating system 110. Similarly, the host device 104 includes an instance of a Java Virtual Machine (JVM) 107 running on an operating system 112. An agent can be load into the JVMs as part of the initialization to create the instance of the JVM. In this example, an agent 160 is loaded into the JVM 106, and an agent 161 is loaded into the JVM 107.

The JVM 106 can also include various application components (e.g., servlets) for execution therein. In this example, in response to loading an application X, an application component 170 and an application component 188 are instantiated in the JVM 106 for execution therein. In this instance, the application component 188 can be a database utility configured to interface with a database 189 to access data therein. For example, the application X can be functionality for a business transaction for shipping a product. The application component 170 can provide part of this functionality. For example, the application component 170 can retrieve an address to where a product is to be shipped. Similarly, in response to loading an application Y, an application component 172 is instantiated in the JVM 106 for execution therein. Similar applications being loaded can cause the application components 174-175 to be instantiated in the JVM 107. In this instance, the application component 174 can be a database utility configured to interface with a database 155 to access data therein.

Also, as part of instantiation, the agents in the host device insert one or more probes to at least some of the application components. In this example, the agent 160 inserts probes 140-141 into the application component 170. The agent 160 also inserts probes 142-143 into the application component 171. The agent 161 inserts probes 144-145 into the application component 174. The agent 160 also inserts probes 146-147 into the application component 175. The agents along with the probes monitor execution of the application components to determine various performance metrics of the application components. For example, the probes can include byte code instrumentation.

The probes can collect information as defined by a directives file. For example, the information from the probes may indicate start and stop times of a transaction or other execution flow, or of individual components within a transaction/execution flow. This information can be compared to pre-established criteria to determine if the information is within bounds. If the information is not within bounds, the agent can report this fact to the performance manager (triggering an event) so that appropriate troubleshooting can be performed.

The probes can report a standard set of metrics which include: Common Object Request Broker Architecture (CORBA) method timers, Remote Method Invocation (RMI) method timers, thread counters, network bandwidth, Java Database Connectivity (JDBC) update and query timers, servlet timers, Java Server Pages (JSP) timers, system logs, file system input and output bandwidth meters, available and used memory and EJB (Enterprise JavaBean) timers. A metric can be defined as a measurement of a specific application activity in a given time interval.

Therefore, the probes can monitor for specific events during execution of the application components to determine various performance metrics such as execution time, error rate, etc. For example, in response to the application component 170 receiving a checkout request 120, one of the probes 140-141 can record that a request is received, the type of request, attributes or parameters provided with the requests, etc. In another example, in response to the application component 172 receiving a product details request 122, one of the probes 142-143 can also record that a request is received, the type of request, attributes or parameters provided with the requests, etc.

The probes can then forward the data collected regarding the various events occurring in the application components to their associated agent. In this example, the probes 140-143 forward their collected data to the agent 160, and the probes 144-147 forward their collected data to the agent 161. In turn, the agents 160-161 forwards the collected data to the performance manager 152. The agents thus collect and summarize information received from the probes.

The performance manager 152 can access a storage device 153 to store the data received from the agents. In some applications, some large organizations employ a central network operations center where one or more performance managers obtain data from a number of distributed agents at different geographic locations. To illustrate, a web-based e-commerce enterprise might obtain agent data from servers at different geographic locations that receive customer orders, from servers that process payments, from servers at warehouses for tracking inventory and conveying orders, and so forth. The performance manager 120 and a user interface might be provided at a corporate headquarters location. Other applications which are not necessarily web-based or involve retail or other sales, similarly employ agents and performance managers for managing their systems. For example, a bank may use an application for processing checks and credit accounts. Moreover, in addition to the multi-computing device arrangements mentioned, a single computing device can be monitored as well with one or more agents.

FIG. 1 also depicts processing of the requests 120-122 after initialization (e.g., instantiation the agents and the application components, insertion of probes, etc.). The request 120 is received by the application component 170. As part of its execution, the application component 170 calls the application component 188, which executes to access data from the database 189. Also as part of its execution, the application component 170 calls the application component 174 in the host device 104. As further described below, the call includes a calling context, which includes values of one or more selected attributes and a path from the top of the application stack to the application component 174. As part of its execution, the application component 174 calls the application component 175, which executes to access data from the database 155. After completing its execution, the application component 175 returns control to the application component 174 to allow for its completion of execution. After completing its execution, the application component 174 returns control to the application component 170 to allow for its completion of execution. After completing its execution, the application component 170 returns a result to the request 120.

The request 122 is similarly processed. However, a different calling context is generated to include with the call to execute by the application component 172 to the application component 174. The request 122 is received by the application component 172. In this example, the application component 172 receives the request 122 because a different set of application components is needed to process the request 122 in comparison to the set of application components needed to process the request 121.

As part of its execution, the application component 172 calls the application component 174 in the host device 104. As further described below, the call includes a calling context, which includes values of one or more selected attributes and a path from the top of the application stack to the application component 174. In this instance, the calling context is different from the calling context provided by the application component 170 because the path from the top of the application stack to the application component 174 is different. Additionally, the attributes selected from the request 122 may be different than the attributes selected from the request 120, which would further differ the two calling contexts. As part of its execution, the application component 174 calls the application component 175, which executes to access data from the database 155. After completing its execution, the application component 175 returns control to the application component 174 to allow for its completion of execution. After completing its execution, the application component 174 returns control to the application component 172 to allow for its completion of execution. After completing its execution, the application component 172 returns a result to the request 122.

Performance Metric Monitoring Example Based on a Calling Context

FIGS. 2-4 are now described. In particular, FIGS. 2-4 depict an example of determining a performance metric based on a calling context, according to some embodiments. FIG. 2 depicts an example 200.

The example 200 includes five host devices—host devices 204-212. The host devices 204-212 can be configured similar to the host devices 102-104 of FIG. 1. For example, each of the host devices 204-212 can include its own agent, wherein one or more probes are attached to some or all of the application components for communication with the agent regarding data used to determine calling context, performance metrics, etc.

The host device 204 includes a transaction 219, an application component #1 225, and an application component #2 223. The transaction 219 is a type of application component that is configured to receive a request. For example, the request can be various requests to perform different types of business transactions. For instance, the transaction 219 can be a servlet to receive a request to checkout in order to purchase an item from a website. In another instance, the transaction 219 can be a request to provide product details for a selected item, product, service, etc. The application component #1 225 and the application component #2 223 can be application components called by the transaction 219 to perform part of a service, generate a result, provide data, etc. as part of processing the request.

The application components in the host device 206 are a replica of the application components in the host device 204 to provide a same functionality. The host device 206 includes a transaction 221, an application component #1 229, and an application component #2 227. The transaction 221 is a type of application component that is configured to receive a request. For example, the request can be various requests to perform different types of business transactions. The application component #1 229 and the application component #2 227 can be application components called by the transaction 221 to perform part of a service, generate a result, provide data, etc. as part of processing the request. While the example 200 depicts one replica, there can a larger number of replicas to allow for the processing of requests from numerous users.

The host device 208 includes an application component #2 231 and an application component 235. The host device 210 includes an application component #1 233, an application component #3 237, and an application component 239. The host device 212 includes an application component #3 241, an application component 243, and an application component 245.

In this example, a request 202 is received by both the transaction 219 and the transaction 221 for processing to help illustrate the different calling contexts at different points in the application stack (as further described below). The request 202 includes four attributes. A first attribute is the type of transaction. The type of transaction can be one of five values (denoted by the five in parenthesis). In this example, the type of transaction of the request 202 is a checkout. A second attribute is a geographic origin of the request. The geographic origin can be one of three values (denoted by the three in parenthesis). For example, the request can provide identification of a source address from which the request originated. The source longitude and latitude can be translated into a geographic origin of the request. The geographic origin can be based on continent, country, state, city, etc. In this example, the geographic origin of the request 202 is Asia.

A third attribute of the request 202 is a user group. The user group can be one of two values (denoted by the two in parenthesis). For example, a group can be put into different categories based on various criteria. For instance, a user can be in a highest level group based on exceeding a highest threshold for money spent on the website. In another instance, a user can pay for being in a higher level user group. In this example, the user group of the request 202 is gold. A fourth attribute of the request 202 is a platform of the device from which the request originated. The platform can be one of three values (denoted by the three in parenthesis). For example, the platform can define what web browser, operating system, etc. executing on the device from which the request originated. For instance, a user device executing web browser N can transmit the request 202 to be received by the host devices 204-206. In this instance, value of the fourth attribute is N.

Some of the application components have been numbered (#1-#3) to define a relationship between application components executing in different host devices. For example, the application component #1 235 in the host device 204 and the application component #1 229 in the host device 206 call the application component #1 233 in the host device 210.

In response to receipt of the request 202, the transaction 219 initiates execution. As part of its execution, the transaction 219 invokes execution of the application component #1 225 and the application component #2 223. Execution of the application component #1 225 and the application component #2 223 may be performed at least partially in parallel. As part of its execution, the application component #1 225 invokes execution of the application component #1 233. As part of its execution, the application component #2 223 invokes execution of the application component #2 231.

As part of its execution, the application component #2 231 invokes execution of the application component 235. As part of its execution, the application component #1 233 invokes execution of the application component #3 237 and the application component 239. Execution of the application component #3 237 and the application component 229 may be performed at least partially in parallel. As part of its execution, the application component #3 237 invokes execution of the application component #3 241.

As part of its execution, the application component #3 241 invokes execution of the application component 243 and the application component 245. Execution of the application component 243 and the application component 245 may be performed at least partially in parallel.

In the example 200, the transaction 219 and the transaction 221 are at the top of the application stack. The application components 243. the application component 245, the application component 235, and the application component 239 are at the bottom of the application stack. As application components at the bottom of the application stack complete execution, these application components can return results, data, etc. back to the application components that invoked their execution. In turn, these application components can complete execution and can return results, data, etc. back to the application components that invoked their execution. Accordingly, execution of the application components can move back up the application stack as application component complete execution.

For example, after completing execution, the application component 243 and the application component 245 can return control to the application component 241. The application component 241 can then complete its execution. After completing execution, the application component 241 can return control to the application component #3 237. The application component #3 237 can then complete its execution. After completing execution, the application component #3 237 and the application component 239 can return control to the application component #1 233. After completing execution, the application component #1 233 can return control to the application component #1 229 and the application component #1 225.

After completing execution, the application component 235 can return control to the application component #2 231. After completing execution, the application component #2 231 can return control to the application component #2 223 and the application component #2 227. After completing execution, the application component #1 225 and the application component #2 223 can return control to the transaction 219. The transaction 219 can then return its results to the device that issued the request 202. After completing execution, the application component #1 229 and the application component #2 227 can return control to the transaction 221. The transaction 221 can then return its results to the device that issued the request 202.

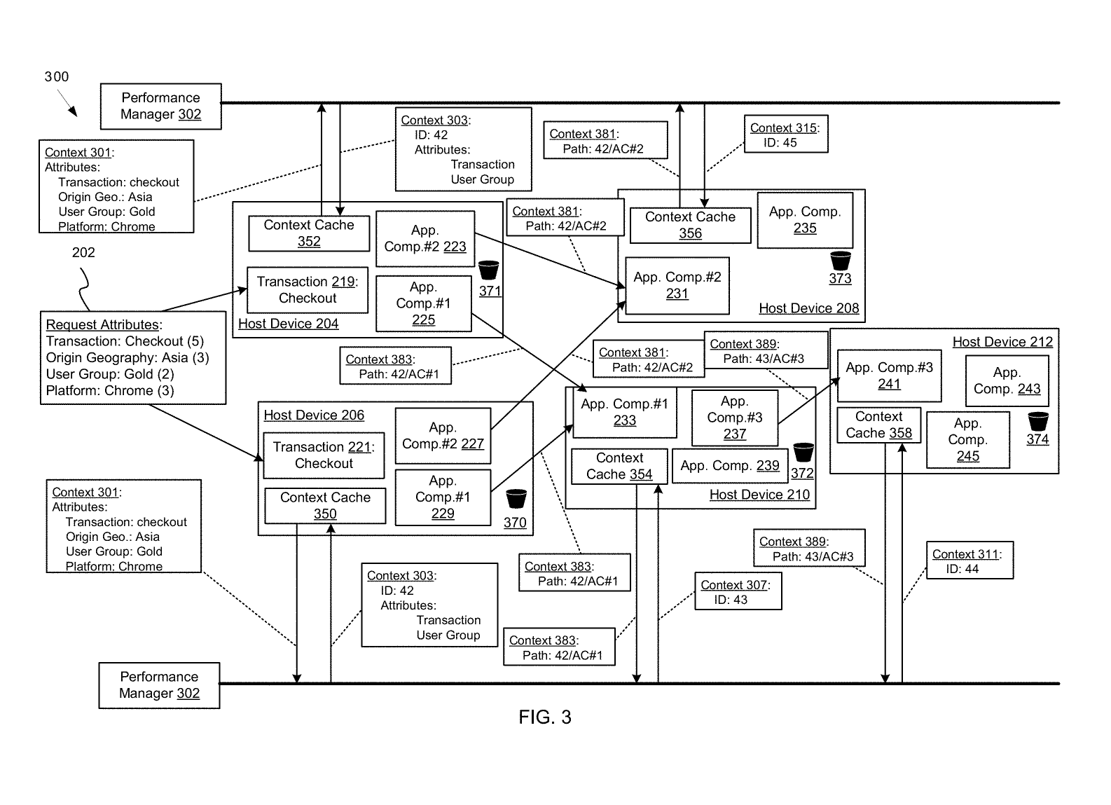

FIG. 3 depicts the example 200 of FIG. 2 and depicts additional details of the calling context being carried down through the application stack. In FIG. 3, an example 300 includes the addition of context cache to each of the host devices. The context cache can be a machine-readable media that stores data related to a context of requests being received and processed by application components in the associated host device. The host device 204 includes a context cache 352. The host device 206 includes a context cache 350. The host device 208 includes a context cache 356. The host device 210 includes a context cache 354. The host device 212 includes a context cache 358.

A performance manager 302 has also been added to the example 300 of FIG. 3. The performance manager 302 can represent the performance manager 152 executing in the management server 150 of FIG. 1. The performance manager 302 is depicted as two different blocks in the example 300. Depiction as two different blocks was included in FIG. 3 for sake of clarity. However, in some embodiments, multiple instances of the performance manager 302 can be created.

The performance manager 302 is communicatively coupled to each of the host devices 204-212. As further described below, the performance manager 302 is configured to communicate with the agent in each of the host devices 204-212 to receive and process calling contexts as application components are executed in the application stack. The performance manager 302 returns to the agent a unique identifier for a given calling context based on a value of one or more attributes of the request and a path from the top of the application stack to a current location in the application stack. The agent can store the unique identifier in its associated context cache. As further described below, this unique identifier is also used to communicate the calling context to an application component further down the application stack.

The example 300 of FIG. 3 also includes one or more accumulators added to each of the host devices 204-212. In particular, the host device 204 includes an accumulator(s) 371. The host device 206 includes an accumulator(s) 370. The host device 208 includes an accumulator(s) 373. The host device 210 includes an accumulator(s) 372. The host device 212 includes an accumulator(s) 374. For example, the accumulators can be some type of register, storage, etc. in a machine-readable media in the host device.

The agent in the host device can create an accumulator for each unique value combination for the attributes that have been selected to be monitored. The attributes that are selected can be a configurable parameter selectable by an administrator, developer, user, etc. that is monitoring performance metrics of the application components. For example, the request 202 includes five attributes. Assume that the selected attributes include transaction and user group. In this example, there are five possible values for transaction and two possible values for user group. There are 10 (5×2) possible combinations of values for the selected attributes. Accordingly, the agent can create 10 accumulators in its host device (one accumulator for each possible combination of values for the selected attributes). In some embodiments, the agent creates an accumulator as a unique value combination of the selected attributes is first received. For example, in response to receiving a request for the first time having a transaction of checkout and a user group of gold, the agent would create an accumulator for this unique combination. Then in response to receiving a request for the first time having a transaction of product details and a user group of gold, the agent would create a second accumulator for this unique combination. This creation of an accumulator continues each time a unique combination of the values of the selected attribute(s) are received.

As further described below, each accumulator stores an accumulated value that comprises an aggregated value for a given performance metric of an application component in the host device. For instance, if the given performance metric is execution time, each time an execution time is determined this value is added to the current accumulated value for the unique combination. For example, assume that an execution time for a particular application component at one of the levels of the application stack for a first request having a transaction of checkout and a user group of gold is 500 milliseconds. The accumulated value for this accumulator is 500 milliseconds. Then, assume that a next execution time for the same application component for a second request having the same values for the selected attributes is 300 milliseconds. The accumulated value for this accumulator is 500 milliseconds plus 300 milliseconds→800 milliseconds. Over time, an average value for this performance metric for this particular application component can be determined by dividing the accumulated value by the number of accumulated values stored in the accumulator.

Accordingly, performance metrics at any level of the application stack can be determined for the different application components based on the specific values of the selected attributes for the original request received at the top of the application stack. In other words, performance metrics can be separated based on the calling context from the top of the application stack at different levels of the application stack.

The example 300 of FIG. 3 also depicts how the calling context of the request is provided to the different levels of the application stack. In particular, in response to the request 202 being received, the agents in the host device 204 and 206 forward a context 301 that includes values of the different attributes of the request 200 (transaction: checkout, origin geography: Asia, user group: gold, and platform: chrome). In this example, the performance manager 302 has been configured to select attributes of the request 200 relative to the performance metric being monitored. For this example, an administrator may have configured the performance manager 302 to select the attributes transaction and user group. Also in this example, the performance metric of the transaction 219 in the host device 204 is being monitored. Similarly, the performance metric of the transaction 221 in the host device 206 is being monitored.

In response to receiving the context 301, the performance manager 302 assigns a unique identifier (42) for a request having a transaction of checkout and a user group of gold. As shown, the performance manager 302 then transmits the context 303 having the unique identifier (42) back to the host devices 204-206. The agents in the host devices 204-206 store the unique identifier (42) in the context cache 352 and the context cache 350, respectively, for this unique combination for these particular values of the two selected attributes (checkout and gold). Additionally, the agent in the host device 204 creates an accumulator 371 for this unique identifier (42) (assuming the accumulator for this unique identifier has not yet been created). The accumulator 371 is for storage of a performance metric (e.g., execution time, error rate, etc.) of the transaction 219. For instance, the accumulator 371 can store an accumulated value of the execution time of the transaction 219 across multiple requests being processed. For example, assume that an execution time of the transaction 219 to a first request is 200 milliseconds. The accumulator 371 stores a value of 200. Then, an execution time of the transaction 219 to a second request is 250 milliseconds. The accumulator 371 stores a value of 200+250→450 milliseconds. An average execution time can then be determined by dividing the accumulated value by the number of requests processed.

Similarly, the agent in the host device 206 creates an accumulator 370 for this unique combination (assuming the accumulator for this unique combination has not yet been created). The accumulator 370 is for storage of a performance metric (e.g., execution time, error rate, etc.) of the transaction 221. Also, the agent in the host device 206 can create an accumulator for each unique combination of values (as described above).

The unique identifier (42) is then used to provide a context to the application components further down the application stack. For example, as part of the application component #2 223 requesting execution by the application component #2 231, the application component #2 223 includes a context 381 that augments a path from the top of the application stack. The path includes the unique identifier (42) and the application component #2→42/AC#2. Similarly, as part of the application component #1 225 requesting execution by the application component #1 233, the application component #1 225 includes a context 383 that includes a path from the top of the application stack. The path includes the unique identifier (42) and the application component #1→42/AC#1.

As part of the application component #2 227 requesting execution by the application component #2 231, the application component #2 227 includes the context 381 that includes a path from the top of the application stack. The path includes the unique identifier (42) and the application component #2→42/AC#2. As part of the application component #1 229 requesting execution by the application component #1 233, the application component #1 229 includes the context 383 that includes a path from the top of the application stack. The path includes the unique identifier (42) and the application component #142/AC#1.

The example 300 of FIG. 3 also depicts how the calling context of the request is provided to the next level the application stack (applications components in the host devices 208-210). In particular, as part of execution of the application component #2 223 and 227, the application components #2 223 and 227 transmit a call to the application component #2 231 for its execution. The call includes the context 381. In response to receiving the call, the agent in the host device 208 forwards the context 381 to the performance manager 302. In this example, the performance metric of the application component #2 231 in the host device 208 is being monitored.

In response to receiving the context 381, the performance manager 302 assigns a unique identifier (45) for a context 315. As shown, the performance manager 302 then transmits the context 381 having the unique identifier (45) back to the host device 208. The agent in the host device 208 stores the unique identifier (45) in the context cache 356 for this unique combination for these particular values of the two selected attributes (checkout and gold) along this path through the application stack. Additionally, the agent in the host device 208 creates an accumulator 373 for this unique identifier (45) (assuming the accumulator for this unique identifier has not yet been created). The unique identifier (45) could then be used to provide a context to the application components further down the application stack. However, in this example, the application stack along this path is at the bottom in the host device 208. Also, the agent in the host device 208 can create an accumulator for each unique combination of values of the attributes of the request being monitored (as described above).

As part of execution of the application components #1 225 and 229, the application components #1 225 and 229 transmit a call to the application component #1 233 for its execution. The call includes the context 383. In response to receiving the call, the agent in the host device 210 forwards the context 383 to the performance manager 302. In this example, the performance metric of the application component #1 233 in the host device 210 is being monitored.

In response to receiving the context 383, the performance manager 302 assigns a unique identifier (43) for a context 307. As shown, the performance manager 302 then transmits the context 307 having the unique identifier (43) back to the host device 210. The agent in the host device 210 stores the unique identifier (43) in the context cache 354 for this unique combination for these particular values of the two selected attributes (checkout and gold) along this path through the application stack. Additionally, the agent in the host device 210 creates an accumulator 372 for this unique identifier (43) (assuming the accumulator for this unique identifier has not yet been created). The unique identifier (43) could then be used to provide a context to the application components further down the application stack (see context 389 below). Also, the agent in the host device 210 can create an accumulator for each unique combination of values of the attributes of the request being monitored (as described above).

As part of execution of the application component #3 237, the application component #3 237 transmits a call to the application component #3 241 for its execution. The call includes the context 389. In response to receiving the call, the agent in the host device 212 forwards the context 389 to the performance manager 302. In this example, the performance metric of the application component #3 241 in the host device 212 is being monitored.

In response to receiving the context 389, the performance manager 302 assigns a unique identifier (44) for a context 311. As shown, the performance manager 302 then transmits the context 311 having the unique identifier (44) back to the host device 212. The agent in the host device 212 stores the unique identifier (44) in the context cache 358 for this unique combination for these particular values of the two selected attributes (checkout and gold) along this path through the application stack. Additionally, the agent in the host device 212 creates an accumulator 374 for this unique identifier (44) (assuming the accumulator for this unique identifier has not yet been created). The unique identifier (44) could then be used to provide a context to the application components further down the application stack. However, in this example, the application stack along this path is at the bottom in the host device 212. Also, the agent in the host device 212 can create an accumulator for each unique combination of values of the attributes of the request being monitored (as described above).

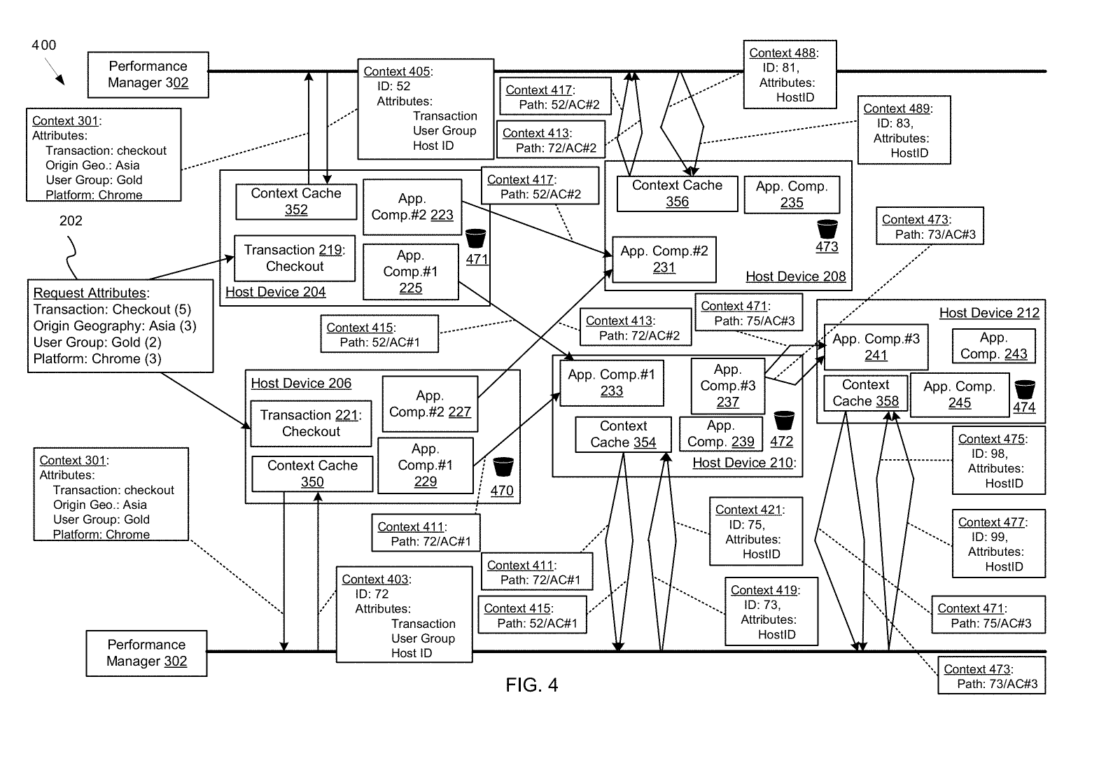

Similar to FIG. 3, FIG. 4 also includes additional details of the calling context being carried down through the application stack. In contrast to FIG. 3, FIG. 4 depicts some embodiments that add additional data to the calling context. In an example 400, the additional data includes identification of the current host device (host ID). An example 400 of FIG. 4 also includes the context cache 350-356 (as depicted in the example 300 of FIG. 3).

Also similar to FIG. 3, FIG. 4 depicts creating of accumulators by agents in the host device. However, in contrast to FIG. 3, the example 400 of FIG. 4 includes host ID as part of each unique value combination. Accordingly, in addition to unique values of selected attributes of the request, identifier (44) is also included to create each unique value combination.

Similar to FIG. 3, FIG. 4 includes selected attributes of the request to be monitored. Assume that the selected attributes include transaction and user group. In this example, there are five possible values for transaction and two possible values for user group. There are five possible values for identification of the host device (204, 206, 208, 210, and 212). In this example, there are 50 (5×2×5) possible combinations of values for the selected attributes and host ID. Accordingly, each agent can create 50 accumulators in its host device (one accumulator for each possible combination of values for the selected attributes and identifier (44)).

As described above, each accumulator stores an accumulated value that comprises a combined value for a given performance metric of an application component in the host device. For instance, if the given performance metric is execution time, each time an execution time is determined this value is added to the current accumulated value for the unique combination. For example, assume that an execution time for a particular application component at one of the levels of the application stack for a first request having a transaction of checkout and a user group of gold and a host ID of AA is 500 milliseconds. The accumulated value for this accumulator is 400 milliseconds. Then, assume that a next execution time for the same application component for a second request having the same values for the selected attributes is 200 milliseconds. The accumulated value for this accumulator is 400 milliseconds plus 200 milliseconds→600 milliseconds. Over time, an average value for this performance metric for this particular application component can be determined by dividing the accumulated value by the number of accumulated values stored in the accumulator.

Accordingly, performance metrics at any level of the application stack can be determined for the different application components based on the specific values of the selected attributes for the original request received at the top of the application stack and the host ID. Also, performance metrics can be separated based on the calling context from the top of the application stack at different levels of the application stack.

The example 400 of FIG. 4 also depicts how the calling context of the request is provided to the different levels of the application stack. In particular, in response to the request 202 being received, the agents in the host devices 204-206 forward the context 301 that includes values of the different attributes of the request 200 (transaction: checkout, origin geography: Asia, user group: gold, and platform: chrome). In this example, the performance manager 302 has been configured to select attributes of the request 200 relative to the performance metric being monitored. For this example, an administrator may have configured the performance manager 302 to select the attributes, transaction and user group. Also in this example, the performance metric of the transaction 219 in the host device 204 is being monitored. Similarly, the performance metric of the transaction 221 in the host device 206 is being monitored.

In response to the request 202, the agent in the host device 204 forwards the context 301 to the performance manager 302. In response to receiving the context 301, the performance manager 302 assigns a unique identifier (52) for a request having a transaction of checkout, a user group of gold and a host ID of 204. As shown, the performance manager 302 then transmits the context 405 having the unique identifier (52) back to the host device 204. The agent in the host device 204 stores the unique identifier (52) in the context cache 352 for this unique combination for these particular values of the two selected attributes (checkout and gold) and the host ID of 204. Additionally, the agent in the host device 204 creates an accumulator 471 for this unique identifier (52) (assuming the accumulator for this unique identifier has not yet been created). The accumulator 471 is for storage of a performance metric (e.g., execution time, error rate, etc.) of the transaction 219. For instance, the accumulator 471 can store an accumulated value of the execution time of the transaction 219 across multiple requests being processed. An average execution time can then be determined by dividing the accumulated value by the number of requests processed.

In response to the request 202, the agent in the host device 206 forwards the context 301 to the performance manager 302. In response to receiving the context 301, the performance manager 302 assigns a unique identifier (72) for a request having a transaction of checkout, a user group of gold and a host ID of 206. As shown, the performance manager 302 then transmits the context 403 having the unique identifier (72) back to the host device 206. The agent in the host device 206 stores the unique identifier (72) in the context cache 350 for this unique combination for these particular values of the two selected attributes (checkout and gold) and the host ID of 206. Additionally, the agent in the host device 206 creates an accumulator 470 for this unique identifier (assuming the accumulator for this unique identifier has not yet been created). The accumulator 470 is for storage of a performance metric (e.g., execution time, error rate, etc.) of the transaction 221. For instance, the accumulator 470 can store an accumulated value of the execution time of the transaction 221 across multiple requests being processed. An average execution time can then be determined by dividing the accumulated value by the number of requests processed.

As shown in the example 400, values of the selected attributes are the same for the request 202 being received. Therefore, if only the values of the selected attributes were used to monitor a performance metric, a same unique identifier could be used (see the unique identifier (42) provided in the context 303 in the example 300 of FIG. 3). However, in the example 400 of FIG. 4, the host ID is also used as part of monitoring the performance metric. Specifically, the performance manager 302 assigns two different unique identifiers (52 and 72) in response to receiving the same context 301 from two different host devices (204 and 206, respectively).

As described above, the agent in the host device 204 can create the accumulator 471 for each unique combination of values. Accordingly, assume there are two attributes of the request that are to be monitored. Also, assume the first attribute has five possible values and the second attribute has two possible values. Also, in this example, the host ID is also being used to differentiate requests for performance monitoring. For this instance, the host ID has five possible values (204, 206, 208, 210, and 212). In this example, the agent in the host device 204 could create 50 possible accumulators to account for each of the possible value combinations of the attributes and host ID to be monitored. In some embodiments, the agent in the host device 204 creates the accumulator as the value combination is received in a request.

Similarly, the agent in the host device 206 creates the accumulator 470 for this unique identifier (72) (assuming the accumulator for this unique identifier has not yet been created). The accumulator 470 is for storage of a performance metric (e.g., execution time, error rate, etc.) of the transaction 221. Also, the agent in the host device 206 can create an accumulator for each unique combination of values (as described above).

The unique identifier (52) is then used to provide a context to the application components further down the application stack. For example, as part of the application component #2 223 requesting execution by the application component #2 231, the application component #2 223 includes a context 417 that includes a path from the top of the application stack. The path includes the unique identifier (52) and the application component #2→52/AC#2. Similarly, as part of the application component #1 225 requesting execution by the application component #1 233, the application component #1 225 includes a context 415 that includes a path from the top of the application stack. The path includes the unique identifier (52) and the application component #1→52/AC#1.

As part of the application component #2 227 requesting execution by the application component #2 231, the application component #2 227 includes a context 413 that includes a path from the top of the application stack. The path includes the unique identifier (72) and the application component #2→72/AC#2. As part of the application component #1 229 requesting execution by the application component #1 233, the application component #1 229 includes a context 411 that includes a path from the top of the application stack. The path includes the unique identifier (72) and the application component #1→72/AC#1.

The example 400 of FIG. 4 also depicts how the calling context of the request is provided to the next level the application stack (applications components in the host devices 208-210). In particular, as part of execution of the application component #2 223 or 227, the application component #2 223 or 227 transmits a call to the application component #2 231 for its execution. The call from the application component #2 223 includes the context 417. In response to receiving the call, the agent in the host device 208 forwards the context 417 to the performance manager 302. In this example, the performance metric of the application component #2 231 in the host device 208 is being monitored. Similarly, the call from the application component #2 227 includes the context 413. In response to receiving the call, the agent in the host device 208 forwards the context 413 to the performance manager 302. In this example, the performance metric of the application component #2 231 in the host device 208 is being monitored.

In response to receiving the context 417, the performance manager 302 assigns a unique identifier (81) for a context 488. As shown, the performance manager 302 then transmits the context 488 having the unique identifier (81) back to the host device 208. The agent in the host device 208 stores the unique identifier (81) in the context cache 356 for this unique combination for these particular values of the two selected attributes (checkout and gold) and the host ID of 208 along this path through the application stack. Additionally, the agent in the host device 208 creates a first accumulator 473 for this unique identifier (81) (assuming the accumulator for this unique identifier has not yet been created).

Similarly, in response to receiving the context 413, the performance manager 302 assigns a unique identifier (83) for a context 489. As shown, the performance manager 302 then transmits the context 489 having the unique identifier (83) back to the host device 208. The agent in the host device 208 stores the unique identifier (83) in the context cache 356 for this unique combination for these particular values of the two selected attributes (checkout and gold) and the host ID of 208 along this path through the application stack. Additionally, the agent in the host device 208 creates a second accumulator 473 for this unique identifier (83) (assuming the accumulator for this unique identifier has not yet been created).

The unique identifier (81 and 83) could then be used to provide a context to the application components further down the application stack. However, in this example, the application stack along this path is at the bottom in the host device 208. Also, the agent in the host device 208 can create an accumulator for each unique combination of values of the attributes of the request being monitored and host ID (as described above).

As part of their execution, the application components #1 225 and 229 transmits a call to the application component #1 233 for its execution. The call from the application component #1 225 includes the context 415. In response to receiving the call, the agent in the host device 210 forwards the context 415 to the performance manager 302. In this example, the performance metric of the application component #1 233 in the host device 210 is being monitored. Similarly, the call from the application component #1 229 includes the context 411. In response to receiving the call, the agent in the host device 210 forwards the context 411 to the performance manager 302. In this example, the performance metric of the application component #1 233 in the host device 210 is being monitored.

In response to receiving the context 411, the performance manager 302 assigns a unique identifier (73) for a context 419. As shown, the performance manager 302 then transmits the context 419 having the unique identifier (73) back to the host device 210. The agent in the host device 210 stores the unique identifier (73) in the context cache 354 for this unique combination for these particular values of the two selected attributes (checkout and gold) and host ID along this path through the application stack. Additionally, the agent in the host device 210 creates a first accumulator 472 for this unique identifier (73) (assuming the accumulator for this unique identifier has not yet been created). In response to receiving the context 415, the performance manager 302 assigns a unique identifier (75) for a context 421. As shown, the performance manager 302 then transmits the context 421 having the unique identifier (75) back to the host device 210. The agent in the host device 210 stores the unique identifier (75) in the context cache 354 for this unique combination for these particular values of the two selected attributes (checkout and gold) and host ID along this path through the application stack. Additionally, the agent in the host device 210 creates a second accumulator 472 for this unique identifier (assuming the accumulator for this unique identifier has not yet been created).

The unique identifier (73) is then used to provide a context to the application components further down the application stack. For example, as part of the application component #3 237 requesting execution by the application component #3 241, the application component #3 237 can include a context 473 that includes a path from the top of the application stack. The path includes the unique identifier (73) and the application component #3→73/AC#3. Similarly, the unique identifier (75) is then used to provide a context to the application components further down the application stack. For example, as part of the application component #3 237 requesting execution by the application component #3 241, the application component #3 237 can include a context 471 that includes a path from the top of the application stack. The path includes the unique identifier (75) and the application component #3→75/AC#3.

In response to receiving the call having the context 471 or the context 473, the agent in the host device 212 forwards the context 471 or the context 473 to the performance manager 302. In this example, the performance metric of the application component #3 241 in the host device 212 is being monitored.

In response to receiving the context 471, the performance manager 302 assigns a unique identifier (98) for a context 475. As shown, the performance manager 302 then transmits the context 475 having the unique identifier (98) back to the host device 212. The agent in the host device 212 stores the unique identifier (98) in the context cache 358 for this unique combination for these particular values of the two selected attributes (checkout and gold) and host ID 212 along this path through the application stack. Additionally, the agent in the host device 212 creates a first accumulator 474 for this unique identifier (98) (assuming the accumulator for this unique identifier has not yet been created). The unique identifier (98) could then be used to provide a context to the application components further down the application stack. However, in this example, the application stack along this path is at the bottom in the host device 212.

In response to receiving the context 473, the performance manager 302 assigns a unique identifier (99) for a context 477. As shown, the performance manager 302 then transmits the context 477 having the unique identifier (99) back to the host device 212. The agent in the host device 212 stores the unique identifier (99) in the context cache 358 for this unique combination for these particular values of the two selected attributes (checkout and gold) and host ID 212 along this path through the application stack. Additionally, the agent in the host device 212 creates a second accumulator 474 for this unique identifier (99) (assuming the accumulator for this unique identifier has not yet been created). The unique identifier (99) could then be used to provide a context to the application components further down the application stack. However, in this example, the application stack along this path is at the bottom in the host device 212. Also, the agent in the host device 212 can create an accumulator for each unique combination of values of the attributes of the request being monitored (as described above).

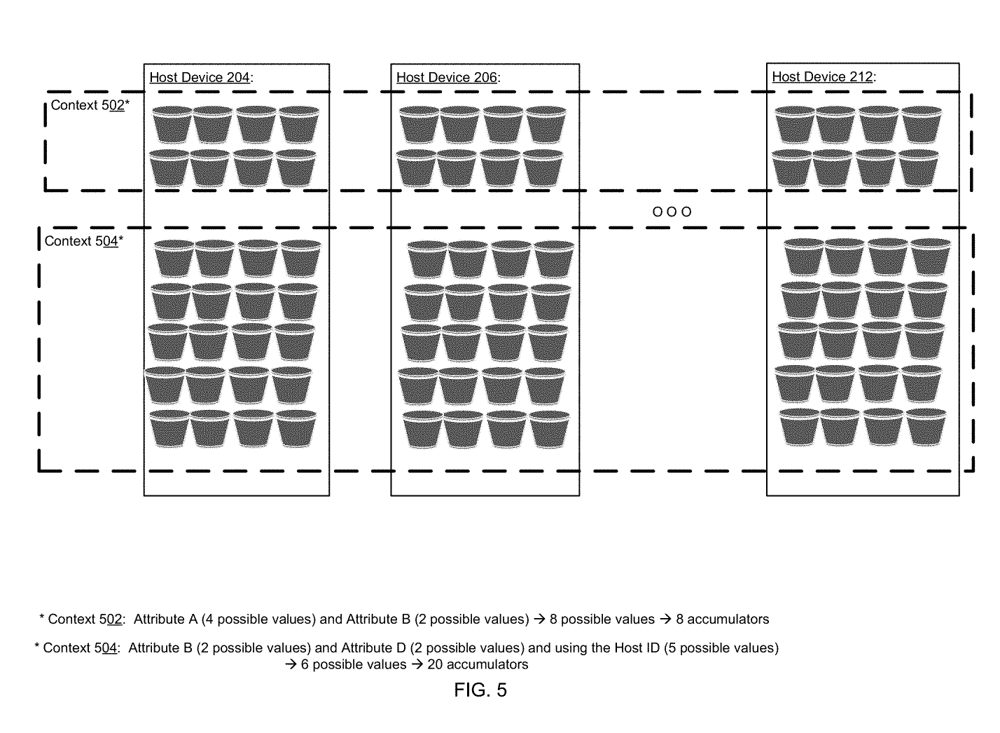

FIG. 5 depicts two examples of the number of accumulators created based on the number possible values of the selected attributes (and number of host devices), according to some embodiments. FIG. 5 depicts three host devices 204, 206, and 212. However, for this example, assume there are five host devices 204, 206, 208, 210, and 212 (similar to the examples depicted in FIGS. 2-4). FIG. 5 also depicts two contexts—a context 502 and a context 504.

The context 502 is for two selected attributes—an attribute A and an attribute B. The attribute A has four possible values, and the attribute B has two possible values. Therefore, in this example, eight (4×2) accumulators can be created in each host device by an agent therein.

The context 504 is also for two selected attributes—the attribute B and an attribute D. The attribute B has two possible values, and the attribute D has two possible values. Unlike the context 502, the context 504 is also based on identification of the host device. The host device ID has five possible values. Therefore, in this example, 20 (2×2×5) accumulators can be created in each host device by an agent therein. Also, each of the accumulators has an associated unique identifier provided by the performance manager 302 (as described above).

Example Operations

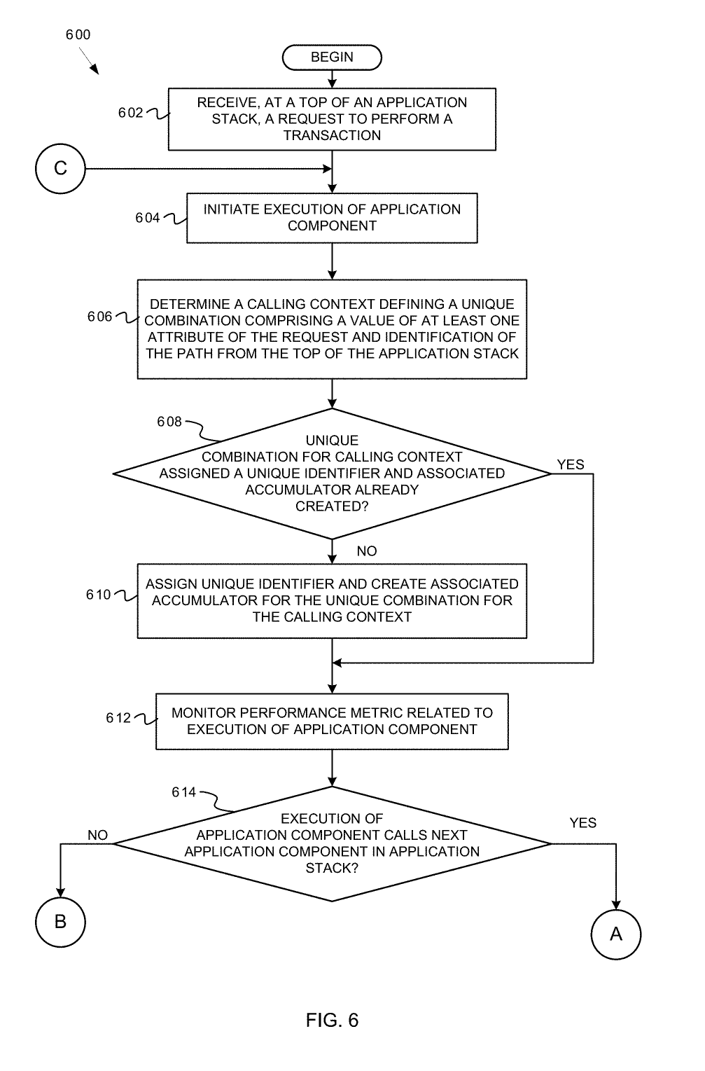

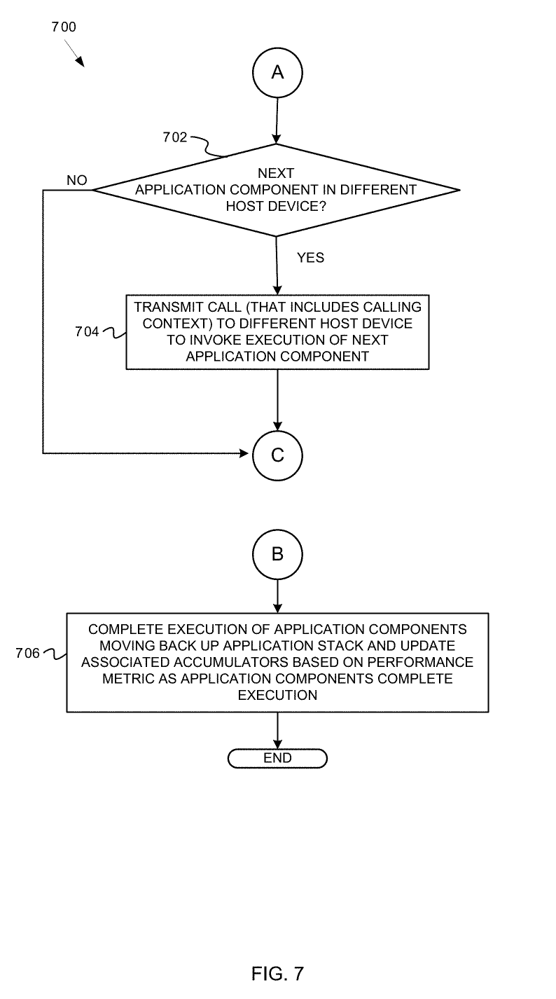

FIGS. 6-7 depict flowcharts that includes performance metric contextualization, according to some embodiments. A flowchart 600 of FIG. 6 and a flowchart 700 of FIG. 7 are described with reference to the example 300 of FIG. 3. Operations of the flowcharts 600-700 are also applicable to the example 400 of FIG. 4. Operations of the flowcharts 600-700 continue between each other through transition points A-C. Operations of the flowcharts 600-700 can be performed by software, firmware, hardware or a combination thereof. The operations of the flowchart 600 start at block 602.

A request to perform a transaction is received at a top of an application stack (602). With reference to FIG. 3, the transaction 219 in the host device 204 or the transaction 221 in the host device 206 receive the request 202. In this example, the transaction 219 or 221 would be considered the application component at the top of the application stack.

Execution of the application component is initiated (604). With reference to FIG. 3, the transaction 219 in the host device 204 or the transaction 221 in the host device 206 is the application component being executed.

A calling context defining a unique combination is determined (606). The unique combination includes a value of at least one selected attribute of the request and a path from the top of the application stack to the current application component being executed. With reference to FIG. 3, the selected attributes included the type of transaction and type of user group of the request. For this example, a value of the type of transaction is checkout, and a value of the type of user group is gold. In some embodiments, the agent executing in the host device 204 or 206 forwards the request 202 to the performance manager 302. The attributes that are selected can be a configurable parameter selectable by an administrator, developer, user, etc. that is monitoring performance metrics of the application components. The performance manager 302 can use this selection to determine the values of the selected attributes. In some embodiments, the performance manager 302 can determine the values by extracting the values from cookies included with the request, data embedded in a HyperText Transfer Protocol (HTTP) request, data included in any query parameters, etc. Also, in some embodiments, ID of the host device is also part of the calling context (as described in reference to the example 400 of FIG. 4). The performance manager 302 can determine ID of the host device based on a source address from which the context 301 is received. In this example, ID of the host device can be the ID for the host device 204 or 206.

A determination is made of whether the unique combination for the calling context has already been assigned a unique identifier and an associated accumulator been created (608). With reference to FIG. 3, the performance manager 302 can make the determination of whether the unique combination for the calling context has already been assigned a unique identifier. For example, the performance manager 302 can perform a lookup into a table of unique combinations that have been assigned to a unique identifier. The agent for the host device having the application component that is being executed determines whether an associated accumulator has been created. With reference to the example 300 of FIG. 3, the agent executing in the host device 204 can determine whether an associated accumulator has been created within a storage in the host device (one of the accumulators 371 associated with the unique identifier). Accordingly, there is a one-to-one relationship between the number of accumulators in a host device and the unique identifiers provided to the host device by the performance manager 302. If a unique identifier has already been assigned and an associated accumulator has been created, operations of the flowchart 600 continue at 612. Otherwise, operations of the flowchart 600 continue at 610.

A unique identifier is assigned and an associated accumulator is created for the unique combination of the calling context of the request (610). With reference to FIG. 3, the performance manager 302 can assign a unique identifier based on unique combination of the values of the selected attributes (and possibly the ID of the host device). For instance, a table can unique combinations for values of these selected attributes (and possibly the ID of the host device) across all the host devices having application components that are part of the application stack. Accordingly, an identifier assigned is unique across all of the host devices. For example, the performance manager 302 can assign unique identifiers in an ascending order starting at some initial value to ensure there is no duplication among assigned identifiers. With reference to the example 300 of FIG. 3, the agent executing in the host device 204 can create the accumulator for this unique combination in some type of machine-readable media (e.g., a hard disk, a random access memory (RAM), a Flash memory, an optical storage device, a magnetic storage device, etc.) in the host device 204.

The performance metric related to execution of the application component is monitored. With reference to FIG. 3, the agent can monitor the performance metric (e.g., execution time, error rate, etc.). For example, with reference to FIG. 1, the probes attached to the application component can provide various data (e.g., event notification, errors generated, etc.). Based on the data received from the probes, the agent can determine the performance metric. For instance, for the example 300 of FIG. 3, the agent in the host device 204 can monitor the execution time of the transaction 219. In this instance, the execution time includes execution time of the application components called directly or indirectly further down in the application stack as part of the execution of the transaction 219. For example, the execution time of the transaction 219 can include the time of execution of the application component #2 223, the application component #2 231, the application component 235, the application component #1 225, the application component #1 233, the application component 239, the application component #3 237, the application component #3 241, the application component 243, and the application component 245.

A determination is made of whether execution of the application component calls a next application component in the application stack (614). With reference to FIG. 3, the agent in the host device can make this determination. For the example 300 of FIG. 3, the agent in the host device 204 determines that the transaction 219 calls the application component #2 223 and the application component #1 225 as part of its execution. If a determination is made that execution of the application component calls a next application component in the application stack, operations of the flowchart 600 continue at transition point A, which continues at transition point A of the flowchart 700. If a determination is made that execution of the application component does not call a next application component in the application stack, operations of the flowchart 600 continue at transition point B, which continues at transition point B of the flowchart 700.

Operations of the flowchart 700 are now described. From transition point A, operations of the flowchart 700 continue at 702.

A determination is made of whether the next application component to be executed is in a different host device (702). With reference to FIG. 3, the agent in the host device can make this determination. For example, a probe attached to the current application component can provide data that includes a destination address of the next application component that is called. Based on the destination address, the agent can determine whether the application component is in a different host device. If the next application component to be executed is in a different host device, operations of the flowchart 700 continue at 704. Otherwise, operations of the flowchart 700 continue at transition point C, which continues at transition point C of the flowchart 600. From the transition point C of the flowchart 600, operations return to initiate execution of the next application component in the application stack. While described as calling one application component, in some embodiments, an application component can call more than one. Accordingly, there can be multiple application components executing at a same time.

A call (that includes the calling context's ID) is transmitted to the different host device to invoke execution of the next application component in the application stack (704). As an example with reference to FIG. 3, the application component #2 223 in the host device 204 calls the application component #2 231 in the host device 208. As shown, the context 381 (the calling context) is included with the call. The context 381 includes a path that defines a path from the top to this point in the application stack. In this instance, the path includes the unique identifier 42 and identification the application component that made the call (AC#2). Based on these two pieces of data, a path from the top of the application stack to the application component #2 231 can be defined. As another example with reference to FIG. 3, the application component #3 237 in the host device 210 calls the application component #3 241 in the host device 212. As shown, the context 389 (the calling context) is included with the call. The context 389 includes a path that defines a path from the top to this point in the application stack. In this instance, the path includes the unique identifier 43 and identification the application component that made the call (AC#3). Based on these two pieces of data, a path from the top of the application stack to the application component #3 241 can be defined. Operations of the flowchart 700 continue at transition point C, which continues at transition point C of the flowchart 600.

From transition point B, operations of the flowchart 700 continue at 706. Execution of the application components complete execution moving back up the application stack (706). Also, the associated accumulators are updated based on a performance metric as application components complete execution. For example, with reference to FIG. 3, the application component #2 231 calls the application component 235 as part of its execution. After the application component 235 completes execution, control moves back up the application stack to the application component #2 231. The application component #2 231 resumes and then completes execution. After its completion, the agent in the host device 208 updates the accumulator for this calling context. For instance, if the performance metric is execution time, the agents adds a value of time of execution completion to the accumulated value stored in the associated accumulator. Continuing up the application stack, after completion by the application component #2 231 in the host device 208, the application component #2 223 can complete its execution. After both the application component #2 223 and the application component #1 225 complete execution, the transaction 219 can complete its execution. After the transaction 219 completes its execution, the agent in the host device 204 updates the accumulator for this calling context. As described above, the accumulator being updated is associated with a performance metric for the transaction 219. For instance, if the performance metric is execution time, the agents adds a value of time of execution completion to the accumulated value stored in the associated accumulator. Operations of the flowcharts 600-700 are complete.

Example Computer Device

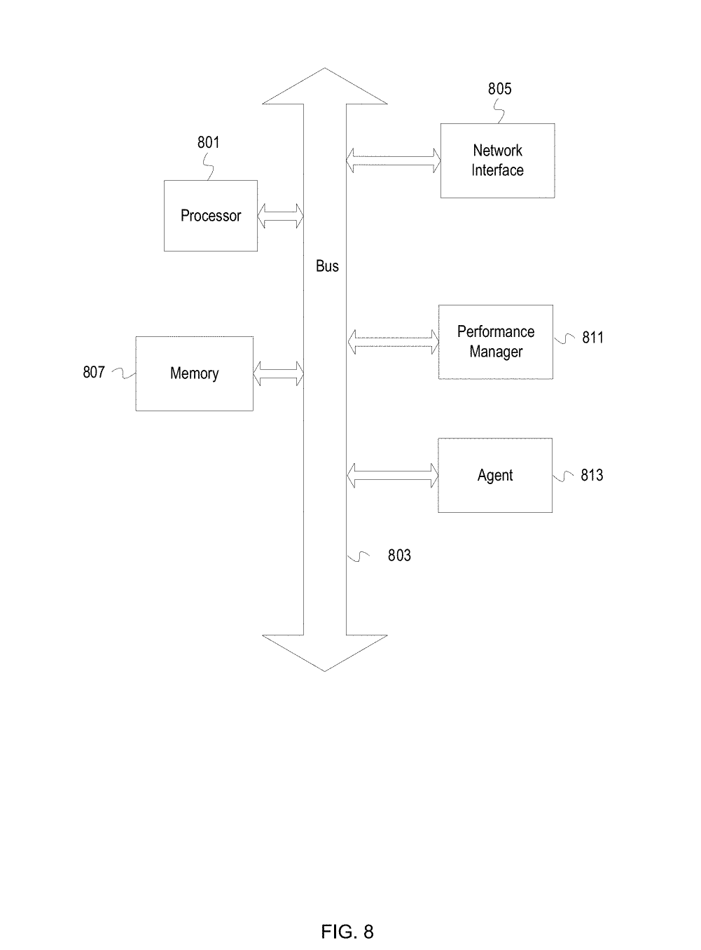

FIG. 8 depicts an example computer device, according to some embodiments. The computer device includes a processor 801 (possibly including multiple processors, multiple cores, multiple nodes, and/or implementing multi-threading, etc.). The computer device includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media.

The computer device also includes a persistent data storage 809. The persistent data storage 809 can be a hard disk drive, such as magnetic storage device. The computer device also includes a bus 803 (e.g., PCI, ISA, PCI-Express, HyperTransport® bus, InfiniBand® bus, NuBus, etc.) and a network interface 805 (e.g., a Fiber Channel interface, an Ethernet interface, an interne small computer system interface, SONET interface, wireless interface, etc.).

The computer device also includes a performance manager 811. The performance manager 811 can perform operations to track events during execution of application(s) and provide unique identifications for different contexts for monitoring performance metrics, as described above. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801, the network interface 805, and the persistent data storage 809 are coupled to the bus 803. Although illustrated as being coupled to the bus 803, the memory 807 may be coupled to the processor 801.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing. Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

While the aspects of the disclosure are described with reference to various implementations and exploitations, it will be understood that these aspects are illustrative and that the scope of the claims is not limited to them. In general, techniques for performing metric contextualization in distributed computing environments as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
based on a first hardware device performing operations of a distributed application stack to process a first request,
determining a first unique combination comprising a first value of an attribute of the first request and identification of a path of execution from a top of the distributed application stack to an application component causing operation of the first hardware device;
assigning a first unique identifier to the first unique combination;
monitoring a performance metric of the first hardware device to determine a first performance value of the first hardware device; and
adding the first performance value to a first accumulator value of a first accumulator that accumulates performance values for the first unique combination.

2. The method of claim 1, further comprising:
determining performance of the first hardware device for the first unique combination based, at least in part, an average value for the performance metric derived from the first accumulator value of the first accumulator.

3. The method of claim 1, further comprising:
based on the first hardware device performing operations of the distributed application stack to process a second request,
determining a second unique combination comprising a second value of the attribute of the second request and identification of the path of execution from the top of the distributed application stack to an application component causing operation of the first hardware device;
assigning a second unique identifier to the second unique combination;
monitoring the performance metric of the first hardware device to determine a second performance value of the first hardware device; and
adding the second performance value to a second accumulator value of a second accumulator that accumulates performance values for the second unique combination.

4. The method of claim 3, further comprising:
determining performance of the first hardware device for the second unique combination based, at least in part, on an average value for the performance metric derived from the second accumulator value of the second accumulator.

5. The method of claim 1, wherein the attribute has a limited set of values.

6. The method of claim 1, wherein the first unique combination comprises an identification of a second hardware device to be invoked in processing the first request.

7. The method of claim 1, wherein the performance metric comprises at least one of an error rate and an execution time of the first hardware device.

8. An apparatus comprising:
a processor; and
a machine-readable medium having program code executable by the processor to cause the apparatus to:
process a first request, wherein the first request comprises an attribute having a first value, and wherein the first request is received at a top of an application stack which has operations performed by a first hardware device, wherein the program code executable by the processor to cause the apparatus to process the first request comprises program code executable by the processor to cause the apparatus to,
execute a first application component within the application stack which causes operation of the first hardware device; and
based on operation of the first hardware device,
determine a first unique combination comprising the first value of the attribute of the first request and identification of a path of execution from the top of the application stack to the first application component;
monitor a performance metric of the first hardware device to determine a first performance value of the first hardware device; and
add the first performance value a first accumulator value of a first accumulator that accumulates performance values for the first unique combination.

9. The apparatus of claim 8 further comprising program code executable by the processor to cause the apparatus to:
determine performance of the first hardware device for the first unique combination based, at least in part, an average value for the performance metric derived from the first accumulator value of the first accumulator.

10. The apparatus of claim 8 further comprising program code executable by the processor to cause the apparatus to:
process a second request, wherein the second request comprises the attribute having a second value, and wherein the second request is received at the top of the application stack, wherein the program code executable by the processor to cause the apparatus to process the second request comprises program code executable by the processor to cause the apparatus to,
execute the first application component within the application stack which causes operation of the first hardware device; and
based on operation of the first hardware device,
determine a second unique combination comprising the second value of the attribute of the second request and identification of the path of execution from the top of the application stack to the first application component;
monitor the performance metric of the first hardware device to determine a second performance value of the first hardware device; and
add the second performance value to a second accumulator value of a second accumulator that accumulates performance values for the second unique combination.

11. The apparatus of claim 10 further comprising program code executable by the processor to cause the apparatus to:
determine performance of the first hardware device for the second unique combination based, at least in part, an average value for the performance metric derived from the second accumulator value of the second accumulator.

12. The apparatus of claim 8, wherein the attribute has a limited set of values.

13. The apparatus of claim 8, wherein the program code executable by the processor to cause the apparatus to execute the first application component within the application stack which causes operation of the first hardware device comprises program code executable by the processor to cause the apparatus to execute the first application component on a first host device and in response to a service call from a second application component in the application stack that executes in a second host device.

14. The apparatus of claim 13, wherein the first unique combination comprises an identification of the second host device.

15. The apparatus of claim 8,
wherein the program code comprises program code executable by the processor to cause the apparatus to, based on operation of the first hardware device, assign a unique identifier to the first unique combination,
wherein the application stack also has operations performed by a second hardware device, wherein the first and second hardware devices operate within a first host device,
wherein the program code executable by the processor to cause the apparatus to execute the first application component comprises program code executable by the processor to cause the apparatus to initiate execution of a second application component which causes operation of the second hardware device, and
wherein the program code executable by the processor to cause the apparatus to initiate execution of the second application component comprises program code executable by the processor to cause the apparatus to transmit a command to initiate execution of the second application component, wherein the command includes the unique identifier assigned to the first unique combination.

16. The apparatus of claim 8, wherein the performance metric comprises at least one of an error rate and an execution time of the first hardware device.

17. One or more machine-readable media comprising program code for metric contextualization in a distributed computing environment, the program code to:
create a first context definition for performance metrics with first parameters of a first hardware device that performs operations of a distributed application stack based, at least in part, on a request to perform a transaction and with an attribute value of the request, wherein the first parameters correspond to an environment of the first hardware device;
associate values of the performance metrics with the first context definition;
for each successive hardware device which performs operations of the distributed application stack for the transaction,
communicate a context definition of an invoking application component to a successive application component which causes operation of the successive hardware device; and
create a successive context definition based, at least in part, on the communicated context definition and a connection parameter associated with operation of the successive hardware device.

18. The one or more machine-readable media of claim 17, wherein the connection parameter defines a path from a top of the distributed application stack to the successive application component which causes operation of the successive hardware device.

19. The one or more machine-readable media of claim 17, wherein the first context definition includes an identification of a device comprising the first hardware device.

20. The one or more machine-readable media of claim 17, wherein the performance metrics comprise at least one of an error rate and an execution time of the first hardware device.
